(19) United States
(12) Patent Application Publication
(10) Pub. No.: US 2020/0186852 A1
(43) Pub. Date: Jun. 11, 2020

(54) Methods and Systems for Switching Between Summary, Time-shifted, or Live Content

(71) Applicant: ARRIS Enterprises LLC, Suwanee, GA (US)

(72) Inventors: Shailesh Ramamurthy, Bengaluru (IN); Mahantesh Gowder Chandrasekharappa, Melbourne (AU)

(21) Appl. No.: 16/213,442

(22) Filed: Dec. 7, 2018

(51) Int. Cl. H04N 21/2343; H04N 21/8549; H04N 21/84; H04N 21/431; H04N 21/472; H04N 21/2187; H04N 21/262

(52) U.S. Cl. CPC H04N 21/23439; H04N 21/8549; H04N 21/84; H04N 21/262; H04N 21/47217; H04N 21/2187; H04N 21/4316

(57) ABSTRACT

A system and method are provided which allow multiple viewing states for a user in a network. The method includes the steps of creating a video summary and providing the video summary to the user; providing a video stream, wherein the video stream comprises live or stored video broadcast or streamed in real-time to the user; and providing a switching mode to the user, whereby the user can select to view one or both of the video summary and video stream.

### FIELD

This disclosure relates generally to the field of providing a video summary to users, and more specifically to the field of allowing users to switch from other viewing states to a video summary state.

### BACKGROUND

As the amount of digital content increases manifold, it becomes more relevant to have methods to consume them intelligibly, often in short consumption times.

Traditional television and the Internet are both used to deliver audio/video (AV) content, such as entertainment and educational programs, to viewers. Television programming and other AV content is available not only from traditional sources like broadcast and cable television, but also from computers and mobile computing devices such as smart phones, tablets and portable computers. These devices may receive content via wired or wireless communications networks, in a home, business, or elsewhere.

Adaptive streaming, also known as adaptive bit rate (ABR) streaming, is a delivery method for streaming video over Internet Protocol (IP). ABR streaming is conventionally based on a series of short Hypertext Transfer Protocol (HTTP) progressive downloads which is applicable to the delivery of both live and on demand content. Examples of ABR streaming protocols include HTTP Live Streaming (HLS), MPEG Dynamic Adaptive Streaming over HTTP (DASH), Microsoft Smooth Streaming, Adobe HTTP Dynamic Streaming (HDS), and the like. An ABR streaming client performs the media download as a series of very small files. The content is cut into many small segments (chunks) and encoded into the desired formats. A chunk is a small file containing a short video segment (typically 2 to 10 seconds) along with associated audio and other data. Adaptive streaming relies generally on the use of HTTP as the transport protocol for these video chunks; however, other protocols may be used as well (e.g., Real Time Messaging Protocol (RTMP) is used in HDS).

Playback is enabled by creating a playlist or manifest that includes a series of uniform resource identifiers (URIs). For example, a uniform resource locator (URL) is a species of URI. Each URI is usable by the client to request a single HTTP chunk. A server, such as an origin server, stores several chunk sizes for each segment in time. The client predicts the available bandwidth and requests the best chunk size using the appropriate URI. Since the client is controlling when the content is requested, this is seen as a client-pull mechanism, compared to traditional streaming where the server pushes the content. Using URIs to create the playlist enables very simple client devices using web browser-type interfaces.

Adaptive streaming was developed for video distribution over the Internet, and has long been used (e.g., by Internet video service providers such as Netflix, Hulu, YouTube and the like) to stream AV content, such as video content embedded in a web site, to an ABR streaming client upon request. The ABR client receives the AV content for display to a user.

While tuning into or seeking into any media content, a user may wish to see the summary of the content/story in the content played so far, or a time-shifted version of the content, to get the context of the live-stream content. For instance, if the user has just entered the room where content is currently being played and started seeing the content from the middle, he/she may want to see the summary to understand the story so far (e.g., on his/her companion mobile device so that it does not obstruct other viewers). Currently, there is no method specifically targeted for this. A user may also wish to obtain a video summary for content already recorded or stored on his/her disk. The user may want a summary that can be viewed quickly until a point in the video, from where he/she would like to watch the full-version video.”

This disclosure envisions efficient ways for any user to efficiently watch as well as switch between summary, or time-shifted, or live content. For example, in combined viewing (e.g., a family viewing together on a large screen), the summary can be displayed on a companion device like mobile device.

### SUMMARY

In accordance with one aspect of the invention, a method of providing multiple viewing states to a user in a network is provided. The method includes the steps of creating a video summary and providing the video summary to the user; providing a video stream, wherein the video stream comprises live or stored video broadcast or streamed in real-time to the user; providing a switching mode to the user, whereby the user can select to view one or both of the video summary and video stream.

Another embodiment includes an apparatus for providing multiple viewing states to a user in a network for distributing video over the network. The apparatus can comprise a streaming server configured to receive video content from a source; an encoder configured to encode the video content and configured to provide a video summary for the video content; and a client device configured to receive the video content and the video summary and provide the video content and video summary to the user for viewing.

### BRIEF DESCRIPTION OF THE DRAWINGS

The details of the present disclosure, both as to its structure and operation, may be understood in part by study of the accompanying drawings, in which like reference numerals refer to like parts. The drawings are not necessarily to scale, emphasis instead being placed upon illustrating the principles of the disclosure.

FIG. 1 is a block diagram illustrating a system capable of adaptive streaming.

FIG. 2 is a high-level schematic illustrating how a summary frame may be derived from a video stream.

FIG. 3 is a state diagram illustrating various viewing states.

FIG. 4 is a high-level overview of a process for generating a video summary.

FIG. 5A is a high-level overview of a process for generating a linear video summary.

FIG. 5B is a high-level overview of a process for generating a storyboard video summary.

FIG. 6 is a high-level overview of a process for generating a semantic summary.

FIG. 7 is a high-level overview of a process for generating an audio summary.

FIG. 8 is a high-level schematic illustrating how a summary window may appear as a secondary window on a primary screen.

FIG. 9 is a high-level schematic illustrating how a summary window may appear on a companion mobile device.

FIG. 10 is a high-level block diagram illustrating content flow in a system.

FIG. 11 illustrates a use case of how a video summary may be used by a viewer arriving late to a TV program.

### DETAILED DESCRIPTION

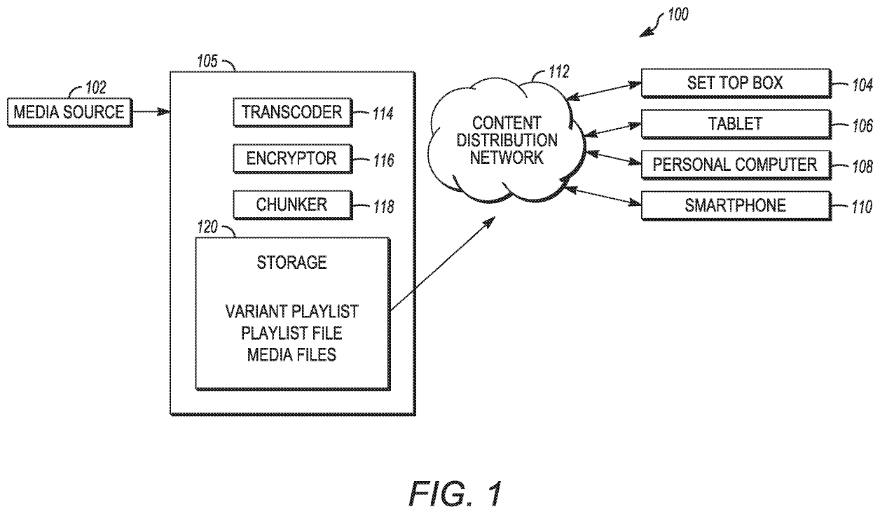

An example embodiment of the present invention and its potential advantages are best understood by referring to FIGS. 1-11 of the drawings, like numerals being used for like and corresponding parts of the various drawings. The FIGS. 1-11, discussed below, and the various embodiments used to describe the principles of the present disclosure are by way of illustration only and should not be construed in any way to limiting the scope of the disclosure. Those skilled in the art will understand the principles of the present disclosure may be implements in any suitably arranged mobile communication device, server and clients.

FIG. 1 is a block diagram illustrating a system 100 capable of adaptive streaming in accordance with the present disclosure. In this example, a streaming server 105 receives media content from a source 102 and makes the media content available to various different types of client devices 104 106, 108 and 110 via a content distribution network 112.

Examples of client devices include any electronic device that can communicate with the streaming server 105 and be used in connection with the playing of video and/or audio digital media data. For instance, client devices can include set-top boxes 104, televisions, personal or laptop computers 108, tablets 106 smartphones 110, wireless devices, and other portable or non-portable devices having display screens and/or audio speakers and/or adapted to output signals to other devices having display screens and/or audio speakers.

It will be understood by a person having ordinary skill in the art that the conventional term “set-top box” should not be construed to limit the physical placement or configuration of such a device; for example, a set-top box 104 is not limited to a device that is enclosed in a box, nor is it limited to a device positioned on top of a television set.

Simply for purposes of example, the network 112 can be any network that provides Internet connectivity, and communications can be provided directly over the Internet. However, according to an alternate embodiment, the network may be a network provided by a service provider such as a provider of terrestrial, cable or satellite digital TV. For instance, the network 112 may be a hybrid fiber-coax cable (HFC) network interconnecting a streaming server via a headend of the network and a set-top box or like consumer premise equipment located at a home or other location of a subscriber. In this example, the set-top box 104 may function as a client device for purposes of handling streaming and performing fetches of playlist files and media files from the streaming server 105. The set-top box 104 may output the streamed content for display on a connected monitor or may forward the content to other client devices including tablets 106 personal or laptop computers 108, smartphones 110, and the like that may be connected to a home or local area network to which the set-top box 104 is connected.

As a further alternative, the set-top box 104 or other customer premise equipment may function in sonic aspects as a streaming server and make playlists and media files available to other client devices 106, 108 and 110 connected to the home or local area network. Of course, the use of set-top boxes, customer premises equipment, and home and cable networks are merely provided for purposes of example, and the embodiments disclosed herein are not limited to such networks and devices.

In use, the streaming server 105 obtains a multimedia presentation or the like in any form from an external source 102. The multimedia presentation may first be subject to an encoding and/or transcoding process in an encoder/transcoder 114 whereby a single input stream is turned into a bouquet of streams, each encoded into a different resolution format and bit rate. The term “bouquet” as used herein refers to a collection of related streams, each constituting a unique bit rate and resolution pairing derived from the same original MPEG service. The multiplicity of different stream formats and bit rates enables the content to be sourced to devices with different capabilities, such as smartphone 110, personal computer 108, tablet 106, and set-top box 104 which may be connected to a relatively large high definition television screen or the like in addition, the different bit rates support adaptive streaming, whereby the receiving client has the ability to measure network congestion and request a lower or higher bit rate stream from the source. This can eliminate visual impairments caused by network congestion (e.g. macro-blocking due to dropped packets, frozen frames) at the expense of higher resolution video.

After transcoding, the bouquet of streams may be encrypted in an encryptor 116 or pre-encryptor and then chunked into segments in a chunker 118. The chunking process breaks each stream into time slices (e.g. 10 second period, 20 second period, or the like) and places the stream of packets for that period into a standard file format container that includes the packets and metadata describing the content. The files are placed in storage 120 on the server 105 which can then publish the files via the content distribution network 112 for distribution to the edges of the network (e.g., to smartphone 110, personal computer 108, tablet 106, set-top box 104, and like customer devices or customer premise equipment). The client devices 104, 106, 108 and 110 may pull or fetch the files over the network 112 by the use of standard unicast HTTP Gets or fetches. The adaptive client devices continuously measure network performance and can adaptively request other file chunks containing higher or lower bit rate streams depending on the dynamic bandwidth that the network 112 can support.

Accordingly, the streaming server 105 segments the media data into chunks and stores the chunks in multiple media files that are in a form that may be transferred one-by-one or made available, for instance, via HTTP or other transfer protocol, to any of a population of client devices. In addition, the streaming server 105 also creates a playlist file or manifest corresponding to the segmented media files so that the stream of data can be readily reassembled by client devices after download.

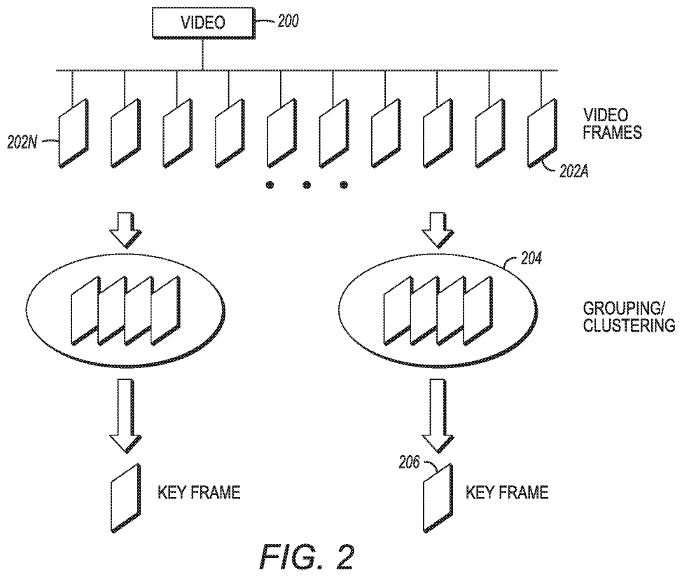

FIG. 2 is a high-level schematic illustrating how a summary frame may be derived from video stream 200. As shown, video stream includes a plurality of frames 202a-202n that contain at least video information. In some embodiments, these frames 202 will comprise frames of video information that will represent an continuous “movie” when displayed sequentially.

The video frames 202 are then clustered or grouped together into groups 204 based on e.g., some sort of significance metrics, such as described in US Patent Application No. 20040085483. For example, the metric may represent a comparison between the graphic content of a given flame and a previous frame in the sequence of frames (most preferably, the given frame will be compared with a most-recent sequentially previous frame). Other indicia. (such as changes to texture) could also be used, alone or in combination, with these criteria as desired. In general, the indicia should be representative of either a scene change and/or motion of one or more depicted objects.

Based on the groups 204, a single summary or key frame 206 may be identified or selected. This single summary or key frame 206 may represent the group 204 as be indicative of frames that appear to represent a significant change in content as compared to a previous frame. For example, the first frame that represents a change of scene in an edited presentation will tend to represent a significant change of visual content as compared to the last frame of the previous scene. As another example, consider a surveillance film of a point-of-sale location in a store. The first frame when a patron first enters the scene will often represent a significant visual change from the preceding frame. Such frames are identified by comparing the significance metric determined above with a first video significance threshold value. This first video significance threshold value can be set as desired and appropriate to a given application, but in general should preferably be set high enough to typically permit accurate identification of such frames that appear to capture the initiation of a significant scene change and/or action sequence. or purposes of this description, such frames are referred to as key frames 206.

In some embodiments, the key frames 206, are used to comprise a visual summary of the original sequence of frames. For example, these selected frames can be displayed in accord with the original frame rate for the original sequence of frames. Since this process typically results in the removal of a considerable number of frames (e.g., all frames that are not key frames and/or that are not otherwise selected), the corresponding resultant summary video will be viewable in a considerably shortened period of time.

In some embodiments, video frames 202 are sampled at about 30 frames per second. In order to perform the video summarization, the frames may be subsampled to yield a frame or two frames every second. Certain features may be extracted using a histogram (RGB histogram or hue histogram from HSV), motion (by detection of temporal redundancies), etc. One frame from each cluster (e.g., the duster center) may be chosen as a key frame 206. As used herein, shots are the segments between the key frames 206, or a series of interrelated consecutive pictures taken contiguously. A shot typically represents a single camera view and is associated with continuous action in time and space.

In some embodiments, determining key frames 206 can be thought of as the problem of finding the frames in a video in that one scene is replaced by another one with different visual content. The determination of key frames and shot detection may include the following steps:
Determine similarity score between consecutive frames: This can be based on SAD (sum of absolute differences) of corresponding pixels, differences in histograms between consecutive frames (wherein the said histogram contains the number of pixels that contain each color/hue) or change in edge characteristics (which in turn involves edge detection, object detection, dilation to compute the probability that the second frame has the similar or dissimilar objects as the previous frame).
Decision n shot boundaries or key frames: A threshold, which is either fixed or adaptive based on the content, is typically used along with the similarity score computed. More sophisticated machine learning techniques based on support vector machine or neural networks can also be used for making this decision.

As described above, the present disclosure provides a method of creation and consumption of video which is intelligible to the user, where the creation of the video involves the creation of video-summary and the consumption of video at the user device involves the facility to switch between video-summary, time-shifted “full version” video and the live video feed. The video can be internet-video (e.g., over the top), video on demand, or conventional broadcast/multicast video.

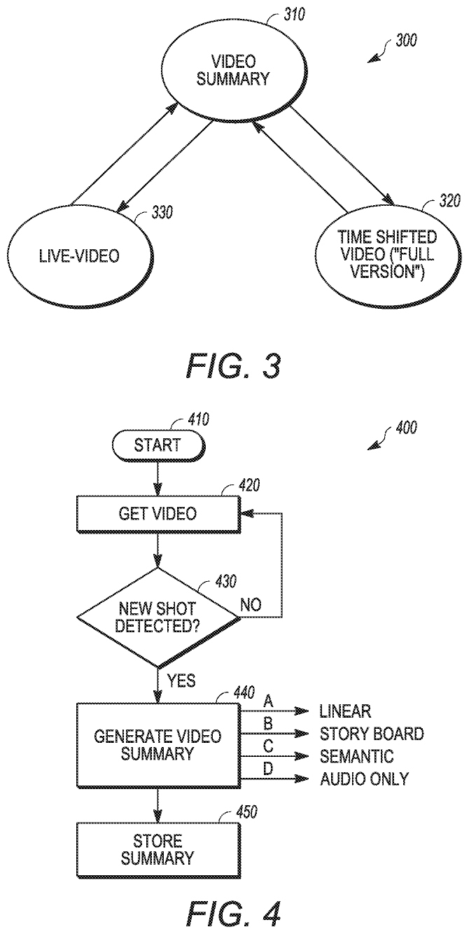

FIG. 3 is a state diagram illustrating available user viewing states 300 in accordance with the present disclosure. The present disclosure enables a user to understand the context of the live-stream in the following forms- video summary 310, time-shifted “full version” video 320 and live video 330. The dramatic increase in the quantity of available video—a trend that is expected to continue or grow exponentially—has increased the need for having a video summary available for the end-user. In some embodiments, an audio-only version of the summary can also be made available to the end-user.

As used herein, video summary 310 obtained out of video summarization refers to a trailer that is automatically created from a longer video. The summary typically extracts important activity in the contained video and ignores the redundant frames that are associated with less interesting or repetitive activity. In sports videos, the summary typically contains important events such as goals scored. In surveillance videos, suspicious activity is ensured to be part of the summary. In home videos or even cinematic content, only the more interesting activities are retained in a crisp manner, in the automatically created video summary. Video summary typically contains those frames which when viewed over a much shorter time interval, would convey semantic information associated with the entire video.

As used herein, time-shifted “full-version” video 320 refers to the long, original video, which is the source content, used for any potential video summarization generated. In some embodiments, specific snippets of video for which a user may want to zoom into would require time-shifted full version (e.g., not only summary of the video) to be available to the user. From a video summary or trailer, the user may be interested to expand it into the full version video for that specific snippet of interest. For example, the user may have an interface containing a mosaic of reduced-size images representing key frames or frames at spaced time intervals, thereby allowing the viewer to readily locate and select a scene of interest to be replayed in this time-shifted “full-version” manner.

As used herein, live-video 330 refers to video, which is broadcast in real time as it occurs, and as it gets captured. This is the video broadcast or streamed real-time to an audience accessing the video stream over a set top box, or over the internet. The viewing device can be a digital screen at home, or a laptop, tablet, smart-phone etc., such as described in FIG. 1.

Thus, from viewing FIG. 3, a user can move in between video summary 310 to live-video 330 and video summary 310 to time-shifted video 320. For this disclosure, the video summary 310 can either be created in real time (e.g., default: linear video summary) or can use offline video summary or can use offline video summary created by methods of the present disclosure.

FIG. 4 is a high-level overview of process 400 for generating a video summary in accordance with the present disclosure. Process 400 begins at step 410, when the process is initiated or started. In some embodiments, the video summary can be generated in advance and stored so that it is available when requested by the user. In other embodiments, the process 400 may be started when the user starts playout of the video in its full-form, the video summary generation can be initiated in parallel, to be ready for any potential switch by user, to the summary mode. At step 420, a video stream is acquired or received. As shown in FIG. 1, the video stream may be provided by media source 102.

At step 430, a shot or new shot is detected. As described above, shots are the segments between the key frames 206. Thus, after a key frame is detected, and before another detected, forms the segment referred to as a “shot”. The shot may be detected by using methods described above,

At step 440, a video summary is created or generated. In some embodiments, the video summary is created at the encoder, transcoder 114, head-end, cloud or an intermediate media aware network element. In other embodiments, the video summarization can also be generated in the customer premise equipment like the set top box (104) or the client device like the tablet (106), smartphone (110) or PC (108) depicted in FIG. 1.

In some embodiments, the video summary may be generated in various forms. For example, the video summary may be a linear summary, a video storyboard, a semantic summary, an audio summary, etc. In some embodiments, a segmented series of shots forms a linear summary. In some embodiments, the user can choose which form of summary he desires to watch. For all video content, it should be ensured that linear-summary is available (or can be made available). The other forms of summary may be available for certain video contents and perhaps not for all contents. If the user choice of say storyboard or semantic is available, the user would be presented with that form of summary. If not available, the default linear-summary would be made available.

Thereafter, at step 450, the summary is stored. In some embodiments, the summary is stored in storage 120. In other embodiments, the summary is stored in headend or media aware network element or on the consumer premise equipment (like the set top) or the end device (e.g., a mobile device/tablet).

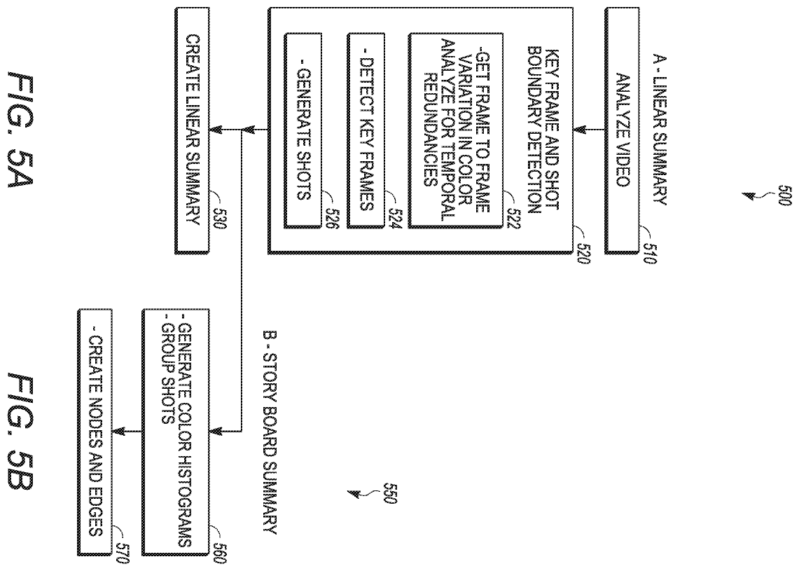

FIG. 5A is a high-level overview of process 500 for generating a linear video summary and FIG. 5B is a high-level overview of process 550 for generating a storyboard video summary in accordance with the present disclosure. Process 500 begins at step 510, where the video is analyzed. In some embodiments, video analysis includes one or more of the following: person detection (e.g., detection of close-ups of faces by use of skin-tone filter and/or other classification techniques), zoom detector, long shot detector. All of these can be used to form interesting thumbnails for the shots.

At step 520, key frame and shot boundary detection is performed. For example, in step 522, the frame-to-frame variation in color may be obtained. Optionally, the frames may be analyzed for temporal redundancies.

At step 524, the key frames are detected. In some embodiments, the key frames are detected using the methods described above, and in the discussion of FIG. 2.

At step 526, the shots are generated. Because the shots are the segments in between the key frames, it is first requisite to detect the key frames. Alternately, shot boundary detection can also be performed first using clustering algorithms (e.g., k-means clustering), and then choosing frames closest to the cluster centers as the key frames. Any frame may be examined first in terms of its similarity with the centroid of clusters. In some preferred embodiments, very short clusters (e.g., less than 1 second) are discarded and not examined for key frames.

If a linear video summary is being generated, at step 530, the linear summary is created. For example, the linear summary may be created by combining the segmented series of shots generated in step 526. In some preferred embodiments, the key frames can be used for forming the linear summary.

As is appreciated, a linear video summary or linear summary includes a collection of key frames (e.g., intra frames of video) extracted from the video. Shot boundary detection and selection of key frames within a shot may be based on lower level video analysis techniques, such as frame-to-frame variation in color distribution or temporal positioning of a frame in a shot. Linear summaries are useful for video sequences where events are not well defined, such as home video.

If desired, a linear summary can be converted to a video storyboard summary (e.g., a graphic representation of the video with nodes and edges). Process 550 for generating a storyboard video summary begins after step 520, wherein key frame and shot boundary detection is performed. At step 560, color histograms are generated and group shots are generated.

In some embodiments, shot boundaries are detected by detecting visual discontinuities. This in turn involves extraction of visual features characteristic of the similarity between frames. For example, in some embodiments, instead of taking differences in pixel domain of each color component, the color statistics can be compared by generating histograms. In some cases, the luminance histograms suffice for the purpose. In some other cases, the color histogram generated by quanitizing the colors may be more useful. The color histograms can be generated using the RGB space or HSV space. As provided above, to determine a shot boundary, the differences of color histograms between frames can be used as a measure of discontinuity. If the histogram is organized in the form of number of occurrences of each color index, the sum of absolute differences between the number of occurrences of corresponding color indexes can be used to obtain the difference of color histograms.

Additionally, in some embodiments, abrupt scene changes manifest where the peak differences occur at cuts. Fades and dissolves manifest as lower amplitude peaks (of differences), which are smoother. Object movements and camera movements also result in even lower and smoother peaks. Hence, by appropriate setting of threshold, the shot boundaries can be detected at only the abrupt scene changes or cuts, as intended.

In some embodiments, a storyboard can be compared to a large comic depicting what the contents in the video. The simplest storyboard comprises of rendering the extracted key-frames as a series of thumbnail images that provide a viewer with a visual indication of the content of the video. A tree like depiction (which shows hierarchical structure of shots) or a graph representation (showing the relationship between shots) can also be used for depicting the storyboard.

At step 570, edges and nodes are created. In some embodiments, nodes are created by grouping shots (e.g., usually on the basis of some low level visual characteristic, such as a color histogram). As used herein,“edges” describe relationships between the nodes and are created by a sophisticated deep-learning system or human annotation along with the summarizing system. For example, human as well as automatic approaches are typically synergistically exercised to bridge the semantic gap between annotated tagging generated by the human experts and machine for the same video. Human annotation is the process where a video is analyzed by humans to annotate appropriately. Shot detection can demarcate between sequence of frames that have a visual discontinuity. To understand the inter-relationships between the shots, human annotation proves useful. This is useful for a semantic representation and/or story⁻board style depiction, which shows the interrelationships between the nodes (shots).

For example, in a sports video, let us say that the consecutive shots contained the following information:
Node N1 covering Shot 1: Player A
Node N2 covering Shot 2: Player B
Node N3 covering Shot 3: Cheering audience
Node N4 covering Shot 4: Player B, a different view
Node N5 covering Shot 5: The overcast sky
Node N6 coveting Shot 6: Player A
Node N7 covering Shot 7: Player A and B in the view of vision

If these shots were depicted as nodes, there could be the following edges connecting the node:
Edge set associated with player A comprising of edges E1, E2, E3, connecting nodes N1, N6 and N7
Edge set associated with player B comprising of edges E4, E5, E6, E7 connecting nodes N2, N4, N6, N7
Edge set associated with miscellaneous shots comprising of E8, E9 connecting nodes N3, N5
Edge set associated with the time-wise linear progression of video shots connecting nodes N1 through N7 in order

Note that n the example above, deep learning that enables discrimination between players based on face and/or number on jersey, recognition of audience scenes, recognition of scenery or nature, can come up with the storyboard automatically. Alternatively, human annotation could be used to identify player A, player B and each of the node contents described above.

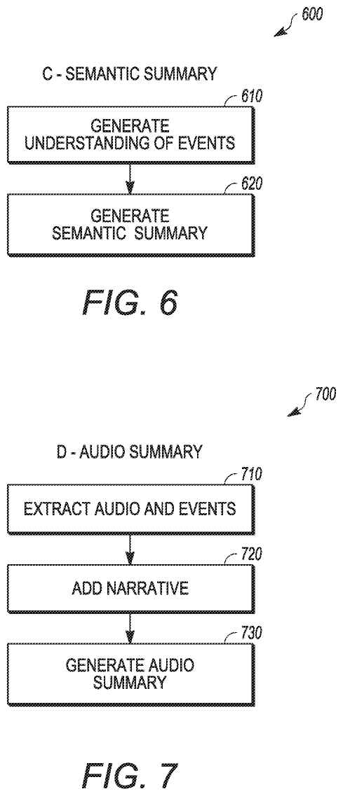

FIG. 6 is a high-level overview of process 600 for generating a semantic summary and FIG. 7 is a high-level overview of process 700 for generating an audio summary in accordance with the present disclosure. In some embodiments, the linear summary is converted to a semantic summary, such as using process 600. Process 600 begins after step 520, wherein key frame and shot boundary detection is performed.

As used herein, the semantic summary focuses on summarization based on meaning of the video content. At step 610, an understanding of events is generated. This can use audio/volume activity/cues in the video (e.g. shouts, applause etc.) as well as closed caption cues. Human annotation can also be used. Thereafter, at step 620 the semantic summary is generated.

In some embodiments, human annotation in video summarization enables infusing of semantic information into the video. Such high level semantic information would be very difficult if not impossible, to glean from the low-level video pixels or features. The shots, which are annotated, should be long enough for the user to understand the contents but short enough to describe it under a single sentence or theme. For example it can be “A group of kids getting ready for professor to arrive”, say in a video depicting a college campus, or “cutting vegetables” for a video or video segment showing how a dish is cooked. As deep learning technologies get better, the proportion of video content, which can be semantically summarized automatically is increasing. Even so, human annotation is important to validate these, or to provide annotations where the video shot does not contain any direct evidence of the annotation. For example, a shot of a terminally ill person, followed by a flickering lamp, which fades away into darkness (e.g., indicative of the fact that the person has unfortunately passed away).

An audio summary can also be generated as shown in process 700. At step 710, audio and events are extracted from the video stream. The audio summary may contain relevant snippets of important audio events. A more full audio-only version of the time-shifted content can also be generated as desired. Narratives of the events that have occurred thus far can be added over and above the sampled version of the main content audio, as shown in step 720. An example of narrative is “John enters the room—finds nobody there. It is dark”. Thereafter, at step 730, the audio summary is generated

In some embodiments, volume is a key acoustic feature that is correlated to the sample amplitudes within each frame. Audio frame energy can also be computed for every frame of shot. After volume and energy levels for every frame in the shot have been computed, the frame(s) with maximum volume and energy can be designated as the predominant frame in the shot. Audio cues such as speech vs. music, pause, tempo, energy, and frequency can be used.

In some embodiments, the audio narrative can also be provided in the language preference of the user, if available or can be made available in that language. In some embodiments, a separate audio file where a narrator describes all the visual information can be created. This audio narrative track can be multiplexed with the main audio track. An option for the user to be able to turn on or off this narrative (in addition to the default audio track) can also be included. Another preferred embodiment uses the automatic read-out or the spoken rendering of the subtitles already available in the content. This can use Text-to-Speech technologies. The subtitles if available in user preferred language can be used for the Text-To-Speech conversion. The user preferred language subtitles can also be displayed to the user.

In addition to these methods of summarization, a user can mark highlights that form the basis of summary when the content is later viewed by the user or other users. Whichever form the specific summary is in, the underlying premise is that viewers require the context of the past happenings in the video to understand the present context, but viewers do not have the time or the desire to watch the entirety of a program, movie or other video presentation. The summary enables the viewer to interactively watch the most relevant portions of the presentation without watching the entire program thus far.

In some embodiments, the video can be internet video (e.g., over the top), video on demand (VOD), or conventional broadcast/multicast video. In internet video or VOD cases, the summary or time-shifted video can easily be streamed over a separate session, onto a secondary window, or a companion mobile device of the end-user, given the pull-model enabled by these mechanisms.

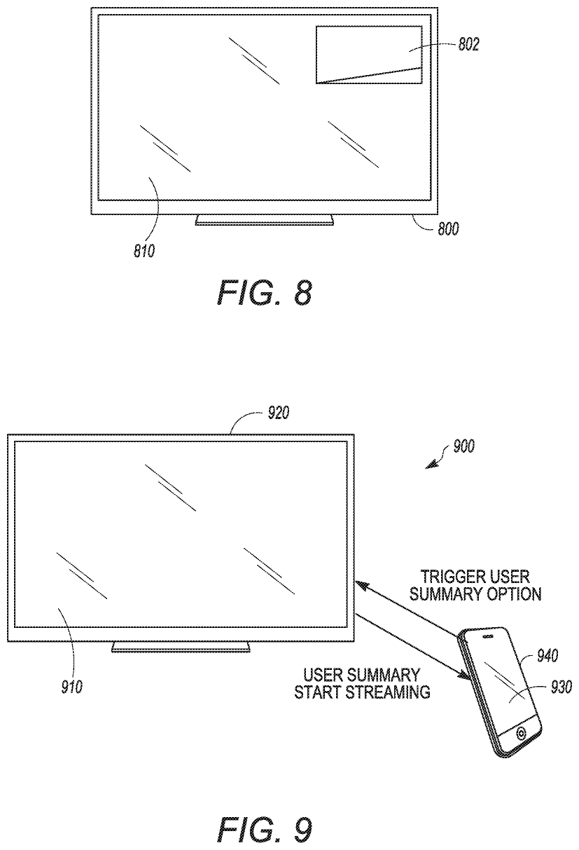

FIG. 8 is a high-level schematic illustrating how a summary window may appear as a secondary window on a primary screen 810 and FIG. 9 is a high-level schematic illustrating how a summary window may appear on a companion mobile device 940. FIG. 8 includes a television (TV) 800 having a main window 810 displaying an audio/video program. TV 800 also includes a picture-in-picture (PiP) window 820 displaying video summary. In some embodiments, PiP window 820 does not include an audio component.

FIG. 9 includes a system 900 made up of a TV 910 and mobile device 940. TV 910 includes a main window 920 displaying an audio/video program. Mobile device 940 includes a TV PiP window 930 displaying video summary with audio and video components. In some embodiments, the user on the mobile device 940 triggers a user summary option, at which point, the user summary begins streaming from TV 910.

In one preferred embodiment, the user can login to his profile on mobile and he/she can select the option to display the summary of the current program with the option on the location to display the summary, including on the mobile or in the PIP window. The user request will be sent to CPE device over WIFI or Bluetooth. Upon receiving the request, CPE device will get the summary (from headend or from its own storage) and start streaming to user mobile device or display in the PiP window. In an alternate embodiment, the user mobile can directly stream the summary over http(s) and display on the mobile device instead of the streaming of content from CPE to mobile device.

In some embodiments (e.g., in the case of conventional broadcast or multicast), the main content is delivered using conventional broadcast methods. Given that the summary or time-shifted content may need to be specific to each user (e.g., given that they may enter at different time-instants, or they may want to zoom-in on a past event as per their preferences), the disclosure provides that the summary or time-shifted content is streamed over-the-top, say, onto the companion device of the user. For example, John may enter a program at 60 minutes after start while Jack may enter 70 minutes past the program. The summary content they see at the 75^{th} minute would typically be different due to their different entry-points, even in cases where the summary across the time-line is the same summary-content.

In some embodiments, the summary may be broadcast to all interested users, but irrespective of their time of entry, all users at any point of time would be watching the same summary content. Given that the entry point in time of different users may be different, a wrapped around, or looped-version of the summary can be broadcast, so that all users interested in the summary can get all parts of summary eventually. In this case, both John and Jack see the same summary content at any point of time, but the wrap-around takes care of completeness of summary.

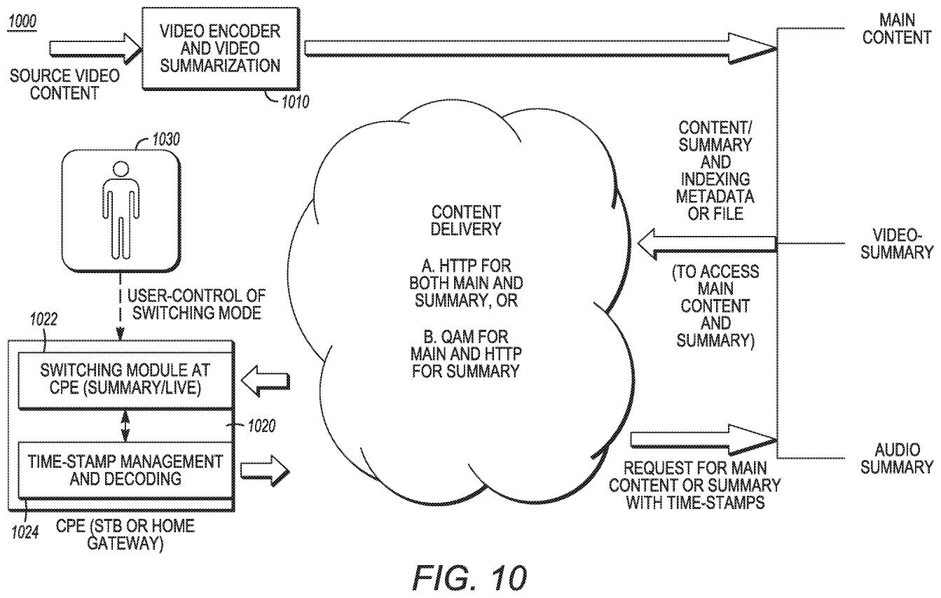

FIG. 10 is a high-level block diagram illustrating content flow in system 1000 in accordance with the present disclosure. System 1000 generally includes video encoder and video summarization 1010, a switching module at customer premises equipment (CPE) 1020, and a customer or user 1030. As described above, source video content is provided to/received by video encoder and video summarization 1010. The resultant content after passing through video encoder and video summarization 1010 may include the main video content as well as a video-summary and optionally audio summary. The content may be provided to the CPE 1020 in a number of ways. For example, using HTTP for the main video content and summary, or using quadrature amplitude modulation (QAM) for the main video content and HTTP for the summary. In some embodiments, the content is provided as the content/summary and an indexing metadata or file, which allow the CPE 1020 to access the main content and summary.

CPE 1020 may include any type of client devices such as home gateways, set-top boxes 104 televisions, personal or laptop computers 108, tablets 106, smartphones 110, wireless devices, and other portable or non-portable devices having display screens and/or audio speakers and/or adapted to output signals to other devices having display screens and/or audio speakers. In some embodiments, CPE 1020 includes a switching module 1022 that allows a user to switch between various viewing states, such as shown in FIG. 3—video summary state 310, time-shifted “full version” video state 320 and live video state 330. For example, suitable user-interfaces allowing the user to switch between the main and summary/time-shifted content may be provided. In such embodiments, the user interface to switch between the main and summary/time-shifted content may be provided either on the CPE device or in the user secondary device including mobile or on both the devices.

CPE 1020 may also include a time-stamp or media-seek management and decoding module 1024. In some embodiments, the media-seek management module 1024 is used to request main content or summary with time-stamps. In some embodiments, the media-seek management module 1024 is responsible for seeking to the correct point in the video and audio media so that the decoding and playout of the audio-video happens from the appropriate point from the user-experience point of view without any discontinuity in the media consumption.

For example, consider the case where a user transitions from the state of live video to video-summary in the linear form. After this transition, let us say the user has watched 10 minutes of the video-summary, which corresponds to the point of live video when he started watching the video-summary. He now would like to seek into the live video at the right point. It is noted that in the 10 minutes he watched the summary, the live video would have advanced 10 minutes. To catch up with live video, he additionally needs to watch video summary that is associated with the 10 additional minutes of live video elapsed. Let us assume that any linear video-summary segment accounts for fraction k of the time taken by the associated live-video segment. As an example, consider fraction k as 1/5. Note that 0<k<1. Thus, in our example, the 10 minutes of live video are associated with 2 minutes of linear video-summary. By the time the 2 minutes of linear video-summary elapse, the live video would have progressed by ⅕ of 2 minutes, which is 24 seconds.

It should be noted that this example can be cast as a geometric progression model. Let Tₜₒₜₐₗ be the total seek time into the live video (with respect to start time of the playout of summary). Now, this total seek time is the sum of two factors: the time it takes for the main summary (T_{summary}) to playout, and a corrective factor (T_{correction}). Thus, T_{summary} is the time factor, which can be correlated to the 10 minutes in the above example cited.

Tₜₒₜₐₗ=T_{summary}+T_{correction}
T_{correction} is the correction factor required, to take care of the fact that the main video advances as the summary is being played out (including the time increments associated with the correction factors like in the example above (e.g., 2 minutes, 24 seconds etc.)
It can be seen that T_{correction}=k*T_{summary}+k*k*T_{summary}+ . . . .

The seek-time into live-video (with respect to start time of playout of summary) can be indicated as

Tₜₒₜₐₗ=T_{summary}+k*T_{summary}+k*k*T_{summary}+ . . . . =T_{summary}/(1−k)

Thus Tₜₒₜₐₗ=T_{summary}/(1−k)

In the above example, the seek-time is 10/(1−⅕)=10/(⅘)=10*5/4=12.5^{th} minute. Thus, the user needs to transition to live video after 12.5 minutes if he wishes to have no discontinuity in media consumption in terms of intelligibility or story line. The factor k is typically signaled as a metadata tag for any video summary that the user consumes. For instance, this metadata tag could be ⅕ or 1/10. It is this factor that helps in efficient seek management. This metadata can be signaled in the playlist of an adaptive bitrate streaming content. Alternatively, it can be signaled in a video elementary stream as SEI (supplemental enhancement information) in AVC, HEVC etc. or as picture user data in MPEG2 video.

Note that practically, the factor k may not be strictly constant. It is however desirable at least in linear-summary that the creation of summary tries to aim for a nearly uniform k. For other forms of video-summary (storyboard/semantic), the above seek-time would be more of an approximation. Note that T_{summary} needs to be obtained from actual time of summary in the respective mode (linear/storyboard/semantic).

As described above, the video summary can either be created in real-time (e.g., on the fly) or can use offline video summary created by methods of the present disclosure or any other video summarization techniques in the art. In cases where the video summary is created in real-time in specific response to a user request, the user can specify the parameter k, which is indicative of the fraction k the video-summary, takes with respect to the associated live-video segment. In other words, k is a time-compression factor associated with the video-summary, relative to the time taken by the full-version video. Also, in a general sense, there can also be multiple summary versions associated with different factors k1, k2, k3, created offline, one of which can be specifically requested by the user. In some embodiments, the user may specify the extent to which he/she wishes to see the video summary. This can be indicated in two ways:
Absolute incremental time—e.g., the user may specify that the next 40 minutes of video be shown in the summary form.
Incremental percentage—e.g., the user may specify that he would like the next 20% of the time of full-version-video-content in the form of video/summary.

In some embodiments, this methods and systems convert these parameters of the user requests, into equivalent values for T_{summary} with the necessary T_{correction}

As shown, the user 1030 is in control of the switching mode, e.g., by accessing the switching module 1022 at CPE 1020. In some embodiments, connectivity between the CPE 1020 rendering content to the main display, and the companion mobile device, are via interfaces such as WiFi or BlueTooth. In some embodiments, a secondary window (PiP) as well as secondary audio support is used, which are typically available. Internet video uses on over the top access mechanisms and the disclosure may rely on separate http sessions for the main content and summary/time-shifted content.

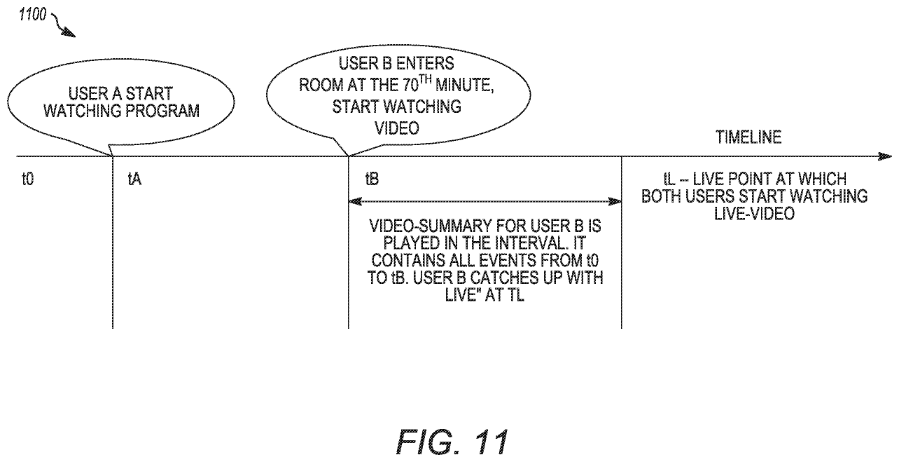

FIG. 11 illustrates a use case of how a video summary may be used by a viewer arriving late to a TV program. Use case 1100 includes a user A and a user B. As shown, a TV show begins at t0. Consider that user A started watching a program from time tA. Consider that user B enters the room where the program is being shown on the main screen, at the 70th minute (tB) of the program. User B is presented with a video-summary on demand, whose content has the events from t0 to the 70^{th} minute. The video-summary (and any time-shifted “full” version for portions desired by user B) is rendered onto the companion device of user B. After the summary/time-shift-content has completed showing all the events until tB, and a delta (which is the time required for playout of summary from time tB), user-B can catch up to live-event at tL if he/she so desires. Of course, user B can continue watching time-shifted content until he/she so desires.

In some embodiments, a uniform resource locator (URL) redirect to live will be useful to switch to live in cases of internet video. The summary stream may include time-stamps with the notion of (a) time-stamps of the summary (b) corresponding time-stamps that associate with the video of the main content. In other words, the time-stamp of the summary may be continuously compared to the time-stamp with respect to main video content, also accounting for how long the summary was played out.

In some embodiments, the disclosure uses markers in the stream that demarcate the summary portions of the video. In some embodiments, manual creation of the summary by insertion of markers in stream may be performed. Of course, more sophisticated video summarization techniques can also be used.

Additional uses of the present disclosure include having visually impaired people use the audio summary to understand program content (e.g., further details of audio summary may be provided). For example, the audio summary can contain a descriptive video service (DVS)-style script that contains an audio narrative corresponding to the summary.

In some embodiments, hearing impaired people can benefit from a closed-caption (CC) style textual summary. This can be provided with the video summary (e.g., just as CC is provided along with the main video content).

As will be appreciated, suitable descriptor tags that correlate the content summary and the main content can be built into future versions of the video standards and the systems specifications thereof.

It should be understood that the various system components can be implemented as physical devices. Alternatively, the system components can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory of a computer. As such, system components (including associated data structures and methods employed within the system components) can be stored on a computer readable medium or carrier, e.g., RAM memory, magnetic or optical drive or diskette and the like.

As disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable storage media for storing information. The term “computer-readable storage medium” includes, but is not limited to, portable or fixed storage devices, optical storage devices, wireless channels, a SIM card, other smart cards, and various other mediums capable of storing, containing, or carrying instructions or data. However, computer readable storage media do not include transitory forms of storage such as propagating signals, for example.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable storage medium and executed by one or more processors.

Although the subject matter has been described in language specific to structural features and/or methodological acts, it is to be understood that the subject matter defined in the appended claims is not necessarily limited to the specific features or acts described above. Rather, the specific features and acts described.

Accordingly, the present disclosure is not limited to only those implementations described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the disclosure. In addition, the grouping of functions within a module or step is for ease of description. Specific functions can be moved from one module or step to another without departing from the disclosure.

The various illustrative modules and method steps described in connection with the implementations disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in a software module executed by a processor, or in a combination of the two. A software module can reside in computer or machine-readable storage media such as RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

While the foregoing is directed to embodiments of the present invention, other and further embodiments of the invention may be devised without departing from the basic scope thereof, and the scope thereof is determined by the claims that follow.

What is claimed is:

1. A method of providing multiple viewing states to a user, comprising:
creating a video summary and providing the video summary to the user;
providing a video stream, wherein the video stream comprises live or stored video broadcast or streamed in real-time to the user; and
providing a switching mode to the user, whereby the user can select to view one or both of the video summary and video stream.

2. The method of claim 1, further comprising:
providing a time shifted version of the video stream to the user.

3. The method of claim 1, wherein the video summary comprises one or more of a linear video summary, a video storyboard, a semantic summary, and an audio summary and wherein the user can select which type of video summary to view.

4. The method of claim 1, wherein the video summary comprises a linear video summary and the method of creating the linear video summary comprises:
identifying one or more key frames or shots; and
sequentially placing the one or more key frames or shots in order to create a visual video summary.

5. The method of claim 4, further comprising:
providing descriptive text that describes the visual video summary with the visual video summary.

6. The method of claim 5, wherein the descriptive text and visual video summary appear as a single video screen shot for a user.

7. The method of claim 5, further comprising:
saving the descriptive text and visual video summary.

8. The method of claim 1, wherein the video summary comprises an audio video summary and the audio video summary comprises extraction of audio events in the form of one or more of: volume, audio energy, speech vs. music, pause, tempo, and frequency.

9. The method of claim 1, wherein the video summary comprises an audio video summary and the audio video summary comprises an audio only version of the entire video content or descriptive audio in the form of audio narration, or a combination thereof

10. The method of claim 1, wherein the video summary is accessible to the user on a primary screen such that the viewer can view the video stream with the video summary as a picture in picture (PiP) window.

11. The method of claim 1, wherein the video summary accessible to the user on a secondary screen such that the viewer can view the video stream on a primary screen and the video summary on the secondary screen.

12. The method of claim 1, wherein the user can switch between viewing the video summary and video stream and wherein said switching mode uses a time compression factor k of the video summary along with the time the summary segment takes for playout T_{summary} in order to seek back into the video stream after a video summary segment has been consumed.

13. The method of claim 12, further comprising signaling the time compression factor k as metadata associated with the video stream.

14. The method of claim 13, wherein said metadata can be signaled in one or more of the following ways: a field in the playlist of an adaptive bitrate streaming content, supplemental enhancement information (SEI) in AVC, HEVC elementary streams, and picture user data in MPEG-2 video.

15. The method of claim 13, wherein if there are multiple summary versions each associated with a different time compression factor k, the user can make a choice in his request for a specific version among the available versions.

16. The method of claim 1, wherein the user can specify the amount of video summary requested in terms of the incremental absolute time or incremental percentage of total time of full-version video.

17. In a network for distributing video over the network, a system for providing multiple viewing states to a user, comprising:
a streaming server configured to receive video content from a source;
an encoder configured to encode the video content and configured to provide a video summary for the video content; and
a client device configured to receive the video content and the video summary and provide the video content and video summary to the user for viewing.

18. The system of claim 17, wherein the video content comprises live video content and/or a time shifted version of the live video content.

19. The system of claim 17, wherein the video summary comprises one or more of a linear video summary, a video storyboard, a semantic summary, and an audio summary.

20. The system of claim 17, wherein the video summary is dependent on human annotation to provide or match the video summary to the video content.
